(19) United States
(12) Patent Application Publication
(10) Pub. No.: US 2018/0145417 A1
(43) Pub. Date: May 24, 2018

(54) RECONFIGURABLE COMPACT ANTENNA DEVICE

(71) Applicants: Centre National de la Recherche Scientifique-CNRS, PARIS CEDEX 16 (FR); Institut National des Sciences Appliquées de Rennes (INSA), RENNES (FR)

(72) Inventor: Jean-Marie FLOC'H, RENNES (FR)

(21) Appl. No.: 15/526,246

(22) PCT Filed: Oct. 29, 2015
(86) PCT No.: PCT/FR2015/052915

§ 371 Date: Sep. 25, 2017

(30) Foreign Application Priority Data
Nov. 12, 2014 (FR) 1402543

(51) Int. Cl. H01Q 9/42; H01Q 1/38; H01Q 1/48; H01Q 5/328; H01Q 5/371; H01Q 5/392

(52) U.S. Cl. CPC H01Q 9/42; H01Q 1/38; H01Q 5/392; H01Q 5/328; H01Q 5/371; H01Q 1/48

(57) ABSTRACT

Some embodiments are directed to an antenna device including an earth conductor and a monopole meander-type radiating element arranged on a first surface of a planar dielectric substrate having two surfaces, the antenna device further including, on a second surface of the dielectric substrate, at least one non-radiating floating planar conductive element, arranged parallel to the radiating element, the non-radiating floating planar conductive element being insulated from the earth conductor.

### CROSS REFERENCE TO RELATED APPLICATION(S)

This application is a national phase filing under 35 C.F.R. § 371 of and claims priority to PCT Patent Application No. PCT/FR2015/052915, filed on Oct. 29, 2015, which claims the priority benefit under 35 U.S.C. § 119 of French Patent Application No. 1402543, filed on Nov. 12, 2014, the contents of each of which are hereby incorporated in their entireties by reference.

### BACKGROUND

Some embodiments are directed to radio signal transmission antenna devices and more particularly to monopole antennas with a meander-type radiating element.

Antennas are essential elements of radio devices. A large number of types of antennas exist and the characteristics that are proper to each one of these types consequently influence the performance in terms of quality and of range of a transmission

Among the antenna structures of small size, the meander antenna is deduced from a quarter-wave monopole. In order to reduce the overall dimensions of the structure, the idea implemented with the meander antenna can consist of in folding back the original monopole into several meanders of equal lengths. The reduction in size is obtained by adjusting the number of meanders and the separation between each one of them. Such a meander antenna can easily be printed on a dielectric substrate. With such a structure, the shortest strands participate preponderantly in the radiation as the surface currents are in phase therein. Inversely, in the longest strands, the surface currents are in opposition of phase. Meander antennas are often defined with respect to their axial lengths, which creates the bulk and the equivalent length of the unfolded meander. It is observed that the resonance frequency of a meander antenna is less than that of the unfolded meander, in particular due to the coupling that exists between the meanders and the bends created by the folding back of the strands. The performance in terms of a reduction of such an antenna is taken via the ratio l of its axial length and of the length L of an unfolded strand resonating at the same frequency. It is further observed that the reduction factor increases with the number of meanders, but also according to the separation of the meanders and of the section of the strand.

### SUMMARY

This meander antenna structure does not however make it possible to achieve an optimum level of reduction in its dimensions.

Some embodiments make it possible to improve the state of the art by proposing an antenna device including a ground conductor connection and a monopole meander-type radiating element, with the radiating element being arranged on a first surface of a planar dielectric substrate having two surfaces. The antenna device further including, on a second surface of the dielectric substrate, at least one floating planar conductive element, arranged parallel to the radiating element, with the one non-radiating floating planar conductive element being insulated from the ground conductor connection.

According to some embodiments, the non-radiating floating planar conductive element is of a size that is substantially identical to that of the radiating element without however taking the same pattern. This means that the maximum dimensions (overall) of the radiating element and of the non-radiating floating planar element are substantially similar but that the floating planar element is designed to act on the global permittivity of the antenna and it does not have the purpose of being a radiating element. In other terms, the floating planar element is not configured to radiate.

According to some embodiments, the shape of the non-radiating floating planar conductive element can be adjusted mechanically for the purposes of modifying the characteristics of the antenna device.

Advantageously, the non-radiating floating planar conductive element includes a liquid metal inserted into an enclosed container, which makes it possible to modify its shape by modification of the shape of the container, for example.

According to some embodiments, the liquid metal is galinstan or mercury.

According to some embodiments, the non-radiating floating planar conductive element is of rectangular or square shape.

### BRIEF DESCRIPTION OF THE FIGURES

Some embodiments shall be better understood, and other particularities and advantages shall appear when reading the following description, with the description referring to the annexed drawings among which:

FIG. 1 is a schematic of a monopole meander antenna device according to related art.

FIG. 2 is a schematic of a monopole meander antenna device according to some particular and non-limiting embodiments.

FIG. 3 is a comparative diagram of the characteristic of a monopole meander antenna device according to some particular and non-limiting embodiments with a meander antenna device according to related art.

### DETAILED DESCRIPTION OF EMBODIMENTS

In FIGS. 1 to 2, the modules shown are functional units, which correspond or do not correspond to units that can be physically distinguished. For example, these modules or some of them are grouped together into a single component, or include functionalities of the same software. On the contrary, according to other embodiments, some modules can include separate physical entities.

FIG. 1 shows a monopole meander antenna device ANT according to related art. According to an embodiment the radiating element RE1 of the antenna ANT, monopole and in the shape of a meander, is printed on a surface of a part D cut into a dielectric substrate of the FR4 type. An incident signal is transmitted to the antenna ANT from a remote generating device via an antenna connection CON. The antenna connection CON is connected to the radiating element RE1 of the antenna ANT as well as to a ground plane GND. The ground plane GND of the antenna ANT is connected to the ground of the remote device that distributes the incident signal to be transmitted via the antenna device ANT. The dielectric substrate D is planar and includes two surfaces S1 and S2. The radiating element RE1 is printed on the surface S1 of the substrate D.

FIG. 2 shows a monopole meander antenna device ANT according to a particular and non-limiting embodiment. According to another embodiment, a planar or substantially planar dielectric substrate D is used and a radiating element RE1 is printed on a surface S1 of the substrate D, as for the antenna shown in FIG. 1, and known to those with ordinary skill in the art.

According to another embodiment, a floating planar conductive element (not connected to the ground) FP1 is positioned on a surface S2 of the dielectric substrate D, opposite the surface S1. According to an advantageous or possible embodiment, the dielectric substrate D comprised of a material of the FR4 type, well known to those of ordinary skill in the art and conventionally used for the manufacture of printed circuits, and the floating planar conductive element FP1 is printed (or screen printed) onto the dielectric substrate D, on the surface opposite that where the radiating element RE1 is located. According to alternatives, the dielectric substrate D includes one or several materials having dielectric properties that are compatible with and useful for a use as a physical support of a radiating element of an antenna. According to an advantageous or possible embodiment of the, the non-radiating floating planar conductive element FP1 is of a size that is substantially identical to the dimensions (width and length) of all or most of the meanders forming the radiating element RE1 of the antenna ANT, and arranged on the surface opposite that carrying the radiating element RE1, “facing” the latter. This planar element however does not have a shape similar to the radiating element RE1, in such a way that it does not function as a radiating element induced by the currents coming from the electromagnetic field emitted by RE1.

“Non-radiating planar conductive element” here means a planar conductive element that is deliberately not configured to radiate since its possible radiation (even accidental) is not an effect that is sought. However, the use of this term and the absence of seeking a radiating effect of the planar element FP1 does not exclude a radiation of very low amplitude resulting from the induced currents coming from RE1 and of an amplitude that is much lower than the desired radiation of the radiating element RE1.

In FIG. 2, the non-radiating floating planar conductive element FP1 is seen by transparency through the substrate (support) D, and this in order to simplify the illustration of the antenna ANT created on the substrate D having two surfaces and carrying the meander radiating element RE1 on a surface S1 and the non-radiating floating planar conductive element on a surface S2 opposite the surface S1.

The presence of the non-radiating floating conductive element FP1, not connected to the ground of the antenna ANT, does not act as a shielding but creates a substantial increase in the permittivity of the dielectric substrate D “seen” by the radiating element RE1. As such, due to the presence of the non-radiating planar conductive element FP1 arranged as indicated hereinabove, for a substrate of the FR4 type, the effective permittivity is increased by a factor that is substantially greater than or equal to two. The initial structure of the antenna is transformed and the behaviour of the antenna is modified in such a way that the antenna then behaves as a microstrip antenna, more than as a dielectric antenna in the air.

Note that the global effective permittivity EPS_{g} of the antenna ANT seen from the radiating element RE1 is according to the permittivity EPSₛ of the materials including the dielectric substrate “support”, of the thickness e of this substrate, as well as the presence of an element w (for example FP1), conductive but not deliberately radiating, positioned “facing” the radiating element RE1, on the surface of the substrate opposite that carrying the radiating element RE1.

The electrical length of the antenna ANT is the inverse function of the square root of the effective permittivity “seen by” the radiating element RE1.

As such, advantageously, the presence of the non-radiating floating planar conductive element FP1 makes it possible to reduce the dimensions of the meander monopole antenna ANT in order to achieve performance in terms of transmission quality and range equal to those that would be obtained in the absence of the non-radiating floating planar conductive element FP1. Advantageously, the overall dimensions of the meander antenna ANT can as such be reduced without this being detrimental to the quality of the transmission of a radio signal representing the incident signal transmitted via conduction to the radiating element RE1, or to the range of this radio signal.

According to an alternative of the embodiment, the dielectric substrate D includes materials such that it can be flexible and that the antenna ANT can be used positioned on a flexible support, such as, for example, a textile support.

Advantageously, the reduced size of the meander antenna ANT, due to the presence of the non-radiating floating planar conductive element FP1, makes it possible, with equal performance, to use the antenna on a textile substrate. Many applications are then possible, such as the integration of an antenna similar to the antenna ANT into a piece of clothing (or a life vest, for example).

The structure of a meander antenna is interesting where such an antenna has a characteristic of a multiband antenna. Advantageously, adding a non-radiating floating planar conductive element FP1 makes it possible to obtain, for an identical radiating element RE1, a larger number of resonance frequencies of the antenna ANT.

It is therefore possible to reconfigure the antenna by modification of the shape of the non-radiating floating planar conductive element, which has the effect of modifying the separations between the different resonance frequencies, as well as their respective positions in the frequency band of the antenna ANT. Thus, according to the desired resonance frequencies, a precise shape of the non-radiating floating planar conductive element FP1 can be defined experimentally in the laboratory and adopted for the manufacture in series of an antenna model ANT, in correlation with a given set of resonance frequencies. Reconfiguring the antenna (also called “reconfigurability”) is made particularly easy since the shape of the non-radiating floating planar conductive element defined as such with precision can be screen printed, or printed for example. According to an alternative of the embodiment, the floating planar conductive element FP1 is associated (or fastened) to an adhesive element (glue or self-adhering surface, for example), and can as such be easily positioned on the dielectric substrate D.

According to another embodiment, the adjusting of the dimensions of the non-radiating floating planar conductive element FP1 is carried out mechanically by sliding (and therefore positioning) of a plurality of non-radiating planar conductive elements, with respect to one another, which has for effect to vary both the shape and the dimensions of the overall non-radiating floating planar conductive element carried out as such.

According to an alternative, a technique of conditioning a liquid metal is used, in a container that can be modified in shape and in the surface occupied, in order to vary the shape and the position of the non-radiating floating planar conductive element FP1 and therefore to reconfigure the characteristics of the antenna ANT (position of the resonance frequencies in the frequency band).

FIG. 3 shows a comparative diagram of characteristics of the monopole meander antenna device ANT according to some particular and non-limiting embodiments with the comparable characteristics of a meander antenna device ANT according to related art.

The curve C1 shows the reflection coefficient according to the frequency of a monopole meander antenna ANT devoid of the non-radiating floating planar conductive element FP1 on the surface S2 of the substrate D. The curve C2 shows the reflection coefficient according to the frequency of a similar monopole meander antenna ANT provided with a floating planar conductive element FP1 on the surface S2 opposite that (S1) carrying the radiating element RE1. An increase in the multi-frequency capacity of the antenna ANT is distinctly observed due to the presence of the non-radiating floating planar conductive element FP1 not connected to the ground GND of the antenna ANT.

In FIG. 3, the reflection coefficient is expressed in dB (decibel) and the frequency is expressed in GHz (gigahertz).

In other terms and according to the particular and non-limiting embodiment, the antenna device ANT includes a ground conductor connection GND and a radiating element RE1 of the monopole meander type arranged on the first surface S1 of the planar dielectric substrate D having two surfaces S1 and S2, the antenna ANT further includes, on the second surface S2 of the dielectric substrate D, at least the non-radiating floating planar conductive element FP1, arranged parallel to the radiating element RE1, the non-radiating floating planar conductive element FP1 being insulated from the ground conductor connection GND of the antenna ANT.

According to an alternative of the embodiment, and with the purpose of more finely adjusting the configuration of the antenna ANT, one or several capacitors CAP are positioned and connected between the meander radiating element RE1 and the non-radiating floating planar conductive element FP1. In the case of a plurality of capacitors CAP (CAP1, CAP2, . . . , CAPn), the latter can be positioned on the surface S2 of the substrate D, around the non-radiating floating planar conductive element FP1 and the connections with the radiating element RE1 on the opposite surface S1 are carried out by electrical connections (V1, V2, . . . , Vn) of the via types (metallised holes passing through the substrate D).

According to a second alternative of the embodiment, one or several varicap diodes D_{VCAP} are positioned between the meander radiating element RE1 and the non-radiating floating planar conductive element FP1.

According to a third alternative of the embodiment, one or several programmable capacitors PCAP are positioned between the meander radiating element RE1 and the non-radiating floating planar conductive element FP1.

Some embodiments do not relate solely to the embodiment described hereinabove but also relates to any monopole meander antenna created on a rigid or flexible substrate having two surfaces and including a non-radiating floating planar conductive element, insulated from the ground, on the surface opposite the surface carrying a meander radiating element. By way of example, the substrate can be made from a material of the Teflon glass type and the non-deliberately radiating floating planar conductive element can be a liquid metal such as galinstan or mercury.

1. An antenna device, comprising:
a ground conductor connection; and
a monopole meander type radiating element, arranged on a first surface of a planar dielectric substrate and at least one not deliberately radiating floating planar conductive element, disposed on a second surface of the dielectric substrate, and arranged parallel to the radiating element, the at least one non-radiating floating planar conductive element being insulated from the ground conductor connection.

2. The antenna device according to claim 1, wherein the at least one non-radiating floating planar conductive element is of a size substantially identical to that of the radiating element in relation to its maximum dimensions, but without similarity in terms of pattern.

3. The antenna device according to claim 1 wherein the at least one non-radiating floating planar conductive element includes a liquid metal inserted into an enclosed container.

4. The antenna device according to claim 1, wherein the liquid metal is galinstan.

5. The antenna device according to claim 1, wherein at least one non-radiating floating planar conductive element is of a rectangular shape.

6. The antenna device according to claim 1, wherein at least one capacitor that is connected between the radiating meander element and the non-radiating floating planar conductive element in order to further adjust the configuration of the antenna is terms of positions of the resonance frequencies.

7. The antenna device according to claim 1, wherein the liquid metal is mercury.

8. The antenna device according to claim 1, wherein at least one non-radiating floating planar conductive element is of a square shape.
